(19) United States
(12) Patent Application Publication
(10) Pub. No.: US 2021/0245012 A1
(43) Pub. Date: Aug. 12, 2021

(54) SYSTEM AND METHOD FOR VESTIBULAR ASSESSMENT AND REHABILITATION

(71) Applicant: OnTrack Rehabilitation, Westport, CT (US)

(72) Inventors: Mrinal KUMAR, Cambridge, MA (US); Prawat TRAIRATVORAKUL, New York, NY (US); Holly ZHOU, Orange, CA (US); Brian BEITLER, New Haven, CT (US); Sinem SINMAZ, New Haven, CT (US); Ian DENZER, New Haven, CT (US)

(21) Appl. No.: 17/170,799

(22) Filed: Feb. 8, 2021

Related U.S. Application Data
(60) Provisional application No. 62/970,943, filed on Feb. 6, 2020.

(51) Int. Cl. A63B 26/00

(52) U.S. Cl. CPC A63B 26/003

(57) ABSTRACT

In some embodiments, a balance board comprises a base plate for positioning the balance board on a surface, a platform coupled to the base plate via one or more adjustable couplings configured to allow changing a stability of the platform. In the balance board, the platform is configured to undergo a tilt in response to a torque applied to the platform; increase a magnitude of the tilt by a tilt increase in response to an increase in a magnitude of the torque by a torque increase; and upon decreasing the stability of the platform, increase a magnitude of the tilt increase in response to the same torque increase.

### RELATED APPLICATION

This non-provisional application claims the benefit of priority to U.S. provisional application No. 62/970,943, filed Feb. 6, 2020, and entitled “SYSTEM AND METHOD FOR CONCUSSION REHABILITATION,” the entire content of which is incorporated herein by reference.

### TECHNICAL FIELD

The present teachings are generally related to systems and methods for facilitating rehabilitation of a patient suffering from a balance disorder.

### BACKGROUND

An estimated 36 million American adults suffer a fall annually. One in 5 of these falls result in a serious injury. Each year, an estimated $50 B is spent on medical costs related to non-fatal and fatal falls.

Balance disorders, defined as any of a set of conditions that make a patient unsteady or dizzy, are amongst the most common causes of adult falls. While vestibular balance disorders may develop naturally as a patient ages, they may also be caused by disease or injury, such as stroke, concussion, or multiple sclerosis. Over 70 million Americans suffer a balance disorder, and it is estimated that these patients have a 12× greater likelihood of suffering a fall than healthy patients. Balance disorders not only increase risk of falls but also significantly hamper patient quality of life, as they may impair activities of daily living such as walking, climbing stairs, and driving.

Well-established literature indicates that vestibular rehabilitation drives significantly improved outcomes for patients with balance disorders. Vestibular rehabilitation is an exercise-based program that is designed to reduce vertigo, dizziness, gaze instability, and falls. It often consists of three principal methods of exercise: 1) habituation, 2) gaze stabilization, and/or 3) balance training. Literature has demonstrated that vestibular rehabilitation results in significant improvements in patient dizziness, balance and functional independence. Further, vestibular rehabilitation has been shown to drive a >70% reduction in fall-risk.

Despite substantial evidence supporting the role of vestibular rehabilitation in improving quality of life and reducing falls for adults with balance disorders, there is a lack of established, affordable tools to implement it. There is a need for a system that allows for standardized diagnosis, assessment, and treatment of vestibular impairment.

### SUMMARY

Though millions of Americans suffer from balance disorders every year, there is a lack of effective assessment and rehabilitative tools for the disorders. Currently, physicians use imprecise assessment methods such as asking patients how they feel on a scale of one to ten. Rehabilitative tools are similarly basic, and even attempts to implement modern vestibular treatment practices are limited by a lack of digitization and quantification. Such approaches to diagnosis and treatment create inconsistencies that may hamper patient recovery and drive poor health outcomes.

In one aspect, the present disclosure provides a device that allows for better assessment and/or rehabilitation of patients with balance impairment. In particular, in some embodiments, the disclosure provides a combination of a balance board and virtual reality (VR) headset to help with the assessment and rehabilitation of patients with balance impairment. In some embodiments, the system can include an adjustable difficulty balance board and a VR headset that can collect information about a patient's balance, head movement, and eye-tracking. It can synthesize this data and present it on a website with an easy-to-use patient and physician interfaces.

The VR plus balance board design allows for a patient to be immersed in a virtual space where they can be given a series of ocular and vestibular tests. The virtual reality can be generated using commercially available devices, such as a Fove VR system with a program written in Unity, and the patient can interact with objects in this environment. A patient wearing the VR headset stands or sits on a balance board according to the present teachings that has load cells and an inertial measurement unit to measure the patient's center-of-gravity and the orientation of the board. The VR headset collects head motion data (translational and rotational) while a camera mounted within the system records eye-tracking data. Additionally, the patient is able to express their subjective experience (e.g., headache, dizziness) to their doctor as they normally do during an exam.

A system according to the present teachings can collect a broad set of diagnostic information as well as stress the patient's ocular and vestibular systems in a way that can aid in a patient's rehabilitation. This data can be interpreted manually by a physician (e.g., through a series of graphics on a web application). In some embodiments, the data can be used to generate a score indicative of how the patient has performed in the various tests.

In one aspect, a balance board is disclosed, which comprises a base plate for positioning the board on a surface, at least one platform configured for supporting a subject thereon, wherein the platform is coupled to the base plate via one or more adjustable couplings configured to allow changing a difficulty for a subject to maintain balance on the at least one platform. The platform can be joined to the base via a central post and a fulcrum to allow tilting the platform along two degrees of freedom.

In some embodiments, the one or more adjustable couplings comprise at least one spring coupled at a first end thereof to the at least one platform and coupled at a second end thereof to the base plate.

In some embodiments, at least one platform can include a top plate and a middle plate, where the top plate is coupled to the middle plate via a plurality of fasteners (e.g., screws) and at least one spring is coupled to the middle plate.

In some embodiments, the middle plate is secured to a ball-and-socket joint that allows rotation of the top and the middle plate about a vertical axis.

In some embodiments, at least one top track is disposed on a bottom surface of the middle plate to which the first end of the at least one spring is coupled. Further, at least one bottom track is disposed on a top surface of the base plate to which the second end of at least one spring is coupled. Each of the top and the bottom tracks extends radially at least partially between the center of the middle plate and the base plate, respectively, and an outer edge thereof.

In some embodiments, the balance board can further include a top carriage for securing the first end of the spring to at least one top track, wherein the top carriage is slidable along the top track. Further, the balance board can include a bottom carriage for securing the second end of the spring to the at least one bottom track, wherein the bottom carriage is slidable along the bottom track. In some embodiments, a load cell can be attached to each corner between the top and the middle plates, where the load cells are configured to measure a force applied to each corner of the top plate.

The balance board can further include circuitry for determining the center of mass of a subject supported by the platform based on the measured forces.

In some embodiments, the balance board can further include an inertial measurement unit (IMU) attached to underneath of the middle plate. The IMU can be configured to measure a tilt of the top and the middle plate.

The balance board can further include at least one gear that is mechanically coupled to a rod, wherein the rod is attached to the bottom carriage so as to convert a rotary motion of the gear into a linear motion of the bottom carriage along the bottom track.

In a related aspect, a system for facilitating rehabilitation of a patient suffering from balance impairment is disclosed, which comprises a balance board providing a platform on which the patient can be supported, the balance board being configured to provide adjustable difficulty to the patient for maintaining balance, a virtual reality device for providing the patient with one or more ocular and/or vestibular tests, and a plurality of sensors coupled to the balance board for generating data for assessing the patient's response to the ocular and/or vestibular tests.

The sensor data can provide information regarding at least one of the patient's balance, head and eye movement.

In some embodiments, a balance board, comprises a base plate for positioning the balance board on a surface, a platform coupled to the base plate via one or more adjustable couplings configured to allow changing a stability of the platform.

In some embodiments, the platform is configured to undergo a tilt in response to a torque applied to the platform; increase a magnitude of the tilt by a tilt increase in response to an increase in a magnitude of the torque by a torque increase; and upon decreasing the stability of the platform, increase a magnitude of the tilt increase in response to the same torque increase.

In some embodiments, the platform is further configured to apply a counter torque to balance against an external torque applied to the platform.

In some embodiments, the platform is further configured to receive a tilt-change resulting from a change in the external torque; and create a change in the counter torque based on the tilt-change, wherein the change in the counter torque balances the change in the external torque.

In some embodiments, the balance board further comprises a force source applying a counter force to the platform, wherein the counter force generates the counter torque.

In some embodiments, decreasing the stability causes the tilt-change to increase for the same change in the external torque.

In some embodiments, the balance board is configured to allow the tilt-change is in two dimensions.

In some embodiments, the force source includes a spring located between the base plate and the platform; and the counterforce includes a compression force applied by the spring to the platform, the compression force resulting from a compression of the spring.

In some embodiments, the tilt-change causes a change in the compression of the spring; the change in the compression of the spring causes a change in the compression force; and the change in the compression force causes the change in the counter torque.

In some embodiments, the spring is configured to be movable radially so as to allow adjusting a distance between the spring and a center of the platform; and the change in the compression of the spring depends on the distance.

In some embodiments, decreasing the distance decreases the stability of the platform.

In some embodiments, decreasing the distance increases the change in compression required to balance the same change in the external torque.

In some embodiments, the force source includes a cable attached to the platform; and the counterforce includes a tension force applied by the cable to the platform.

In some embodiments, the tilt-change causes a change in the tension force.

In some embodiments, the cable is attached by its two ends to two attachment points on the platform; and the tension force results from two cable tensions applied by the cable to the platform at the two attachment points.

In some embodiments, a method comprises detecting an external torque applied to a platform of balance board; based on the determined external torque, determining a counter torque; based on the determined counter torque, determining a tilt of the platform; and based on the determined tilt, tilting the platform.

In some embodiments, determining the tilt includes determining a magnitude of compression of a spring.

In some embodiments, the balance board is a motorized cable balance board, and the spring is included in a spring balance board corresponding to the motorized cable balance board.

In some embodiments, determining the magnitude of the compression depends on a level of instability of the balance board.

In some embodiments, level of instability of the balance board determines a location of the spring.

Further understanding of various aspects of the embodiments can be obtained by reference to the following detailed description in conjunction with the associated drawings, which are described briefly below.

### BRIEF DESCRIPTION OF THE DRAWINGS

The drawings are not necessarily to scale or exhaustive. Instead, emphasis is generally placed upon illustrating the principles of the embodiments described herein. The accompanying drawings, which are incorporated in this specification and constitute a part of it, illustrate several embodiments consistent with the disclosure. Together with the description, the drawings serve to explain the principles of the disclosure.

In the drawings:

FIGS. 1A-1E show different views of a balance board and its parts according to some embodiments.

FIGS. 2A and 2B show block diagrams for two designs of an electronic hub according to some embodiments.

FIGS. 3A-3F show different views of a balance board and its parts according to some other embodiments.

FIG. 4 depicts the electrical system of a balance board according to some embodiments.

FIG. 5 shows a patient positioned on a platform of the balance board, according to some embodiments.

FIG. 6 shows the flow of data between the balance board, computer, and VR system according to some embodiments.

FIGS. 7A-7E show different views of a balance board and its parts according to another embodiment.

FIGS. 8A-8C illustrate the above discussed operation of the motorized cable balance board as compared to the spring balance boards according to some embodiments.

FIG. 8D depicts the process of achieving force modulation of brushless motors via current control, as utilized in some embodiments.

FIG. 9 depicts a diagram of an electrical system of a balance board according to some embodiments.

FIG. 10 show a flow chart for a process performed by a balance board according to some embodiments.

### DETAILED DESCRIPTION

The present disclosure provides a rehabilitation system for use by patients with vestibular impairment. In many embodiments, the system includes a balance board having a platform on which a patient can stand and a virtual reality device that can provide the patient with one or more ocular and/or vestibular tests as the patient is standing and maintaining her balance on the balance board. The balance board can have different settings, each of which presents a different degree of difficulty for the patient to maintain her balance. As discussed in more detail below, a plurality of sensors coupled to the balance board can allow collecting diagnostic data indicative of the patient's response to the ocular and/or vestibular tests, e.g., the patient's ability to maintain her balance.

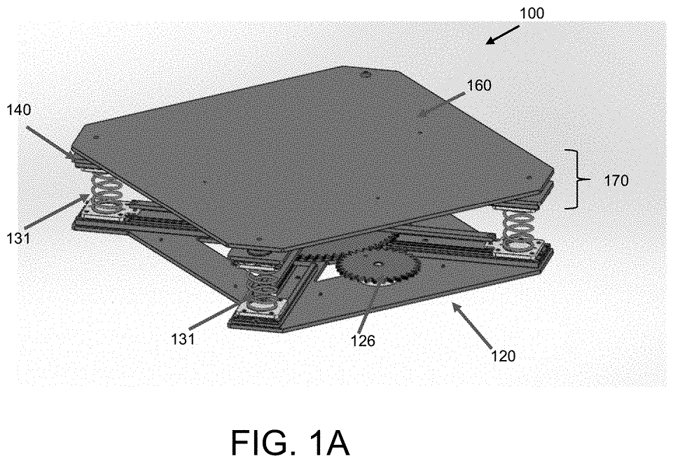

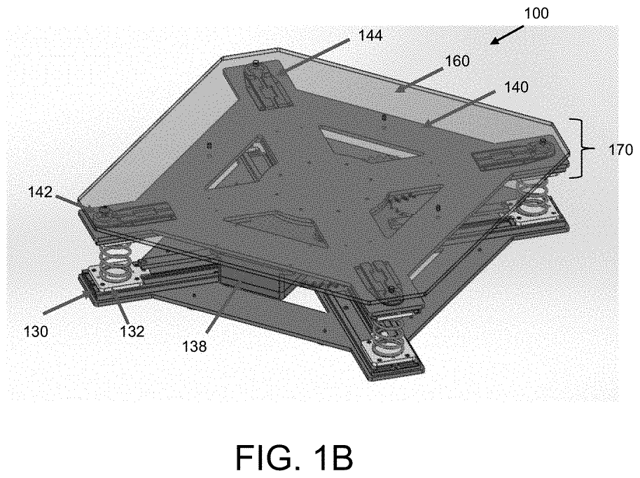

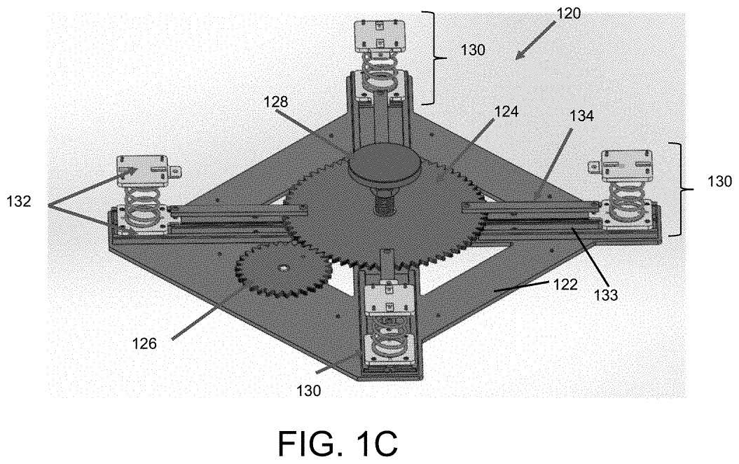

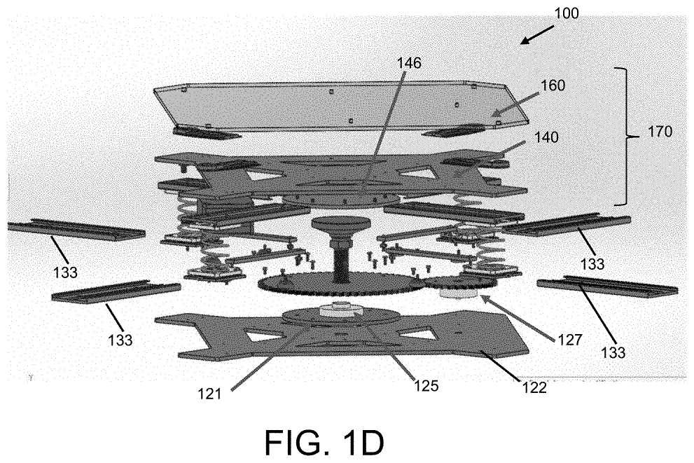

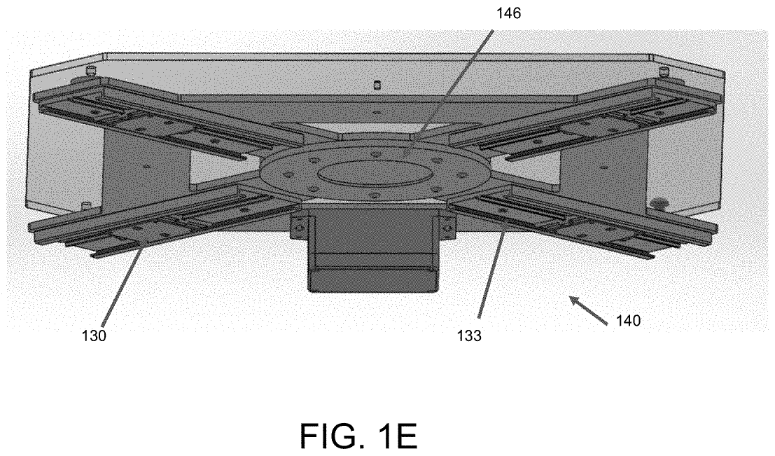

FIGS. 1A-1E show different views of a balance board 100 and its parts according to some embodiments. In some embodiments, a balance board such as balance board 100 is herein referred to as a manual spring balance board for reasons explained further below.

Balance board 100 includes a base assembly 120, a middle plate 140, and a top plate 160.

Moreover, as shown in FIGS. 1A, 1C, and 1D, base assembly 120 includes a base plate circular connector 121, a base plate 122, a large gear 124, a large gear holder 125, a small gear 126, a small gear holder 127, a center joint 128, four spring packs 130, four pairs of rails 133, and four directing rods 134. Each spring pack 130 includes a pair of spring holders 132 which hold between them a spring 131.

Moreover, there exist 4 load cells 142 and four load cell holders 144 between Middle plate 140 and top plate 160. Further, there exists a middle plate connector 146 beneath middle plate 140.

Base assembly 120, middle plate 140, and top plate 160 are supported by center joint 128 and four Springs 131. Each spring 131 is included in one of the spring packs 130; and is confined in its two ends to a pair of spring holders 132 and compressed between base assembly 120 and middle plate 140.

Top plate 160 is fastened to middle plate 140 in the following manner, together forming a platform 170. Top plate 160 is secured rotationally and about the x and y axes by four screws that pass through through-holes in the middle plate 140 and are screwed into top plate 160. This allows for limited movement of the top plate about the z-axis, which is needed in this embodiment for interfacing the top plate with load cells 142, as discussed in more detail below. Four more screws are screwed into the top plate and rest on the top of load cells 142, so that the downward force of the top plate (and whatever rests on the top plate) would be recorded by the load cells.

In one embodiment, middle plate 140 is screwed into a 0.25″-thick middle plate connector 146, which has a circular shape. In this embodiment, middle plate connector 146 has a 4″ diameter, 0.125″-deep indent that is milled into its bottom face so that it can rest securely on top of center joint 128. Center joint 128 has a 4″ diameter plate on top. This allows for the platform (the combination of the top plate and the middle plate fastened together) to rotate securely with center joint 128.

Further, middle plate 140 and base assembly 120 are coupled via four spring packs 130 and center joint 128 as follows. As shown in the FIGS. 1A-1C, each spring pack 130 is confined between a pair of rails 133 that run in parallel on the bottom plate and middle plate. To that end, four rails 133 are provided on the top surface of base plate 122 and run along the diagonals of the top face of the base plate 122. The rails are secured to the base plate via four screws. Further, four other rails 133 are provided on the bottom face of middle plate 140, run along the diagonals of the bottom face of the middle plate, and are secured to the bottom face of the middle plate via screws. Each parallel pair of rails 133 provide a track for the spring pack 130 confined between the pair for moving back and forth between a diagonal corner of base plate 122 and the periphery of large gear 124, as further discussed below.

More specifically, one pair of spring holders 132 are attached to the top and bottom of each spring 131 and slide along a track formed by a pair of parallel rails 133 respectively secured to the bottom surface of middle plate 140 and to the top surface of base plate 122. In this embodiment, each spring holder is connected to a respective spring using a 3D-printed adapter via four screws. In other embodiments, the spring holders may be attached to the respective springs using other mechanisms. Each of the spring holders can slide within the respective pair of rails 133 to move the associated spring diagonally from the center of the plate towards its associated corner.

In one embodiment, base plate 122, middle plate 140, and top plate 160 are made from 0.25″ aluminum. Also, a 0.25-inch-thick disk of aluminum is used for base plate circular connector 121 and is secured to the top of the bottom plate with eight screws. It contains a 1″ diameter tapped hole through which the threaded rod attached to center joint 128 is screwed. The base plate circular connector is secured to the top face of base plate 122 with eight screws. These screws are in turn secured by lock nuts. The base aluminum plate has a 2″-diameter, 0.125″-thick indent which houses a nut that secures center joint 128 threaded rod at the bottom.

In this embodiment, both gears 124 and 126 are fabricated from 0.25″-thick delrin. Large gear 124 rotates using the center joint threaded rod as an axis. It sits on top of the aluminum plate and is secured to the top face of the bottom layer of aluminum using a 3D printed large gear holder 125. Four screws attach the ends of the four directing rods 134 to the periphery of the gear 125. The other ends of these rods attach to the four bottom spring holders 132 via screws, one per adapter. This system allows the rotational movement of the gear to be converted into the translational movement of the spring pack spring system. An outer small gear 126 is enmeshed with the large gear. The small gear rotates about a shoulder screw and allows an operator of the balance board to rotate the large gear from outside the board. A metal peg can be inserted into a hole near the outside of the small gear and keeps the gear system stationary when rotation is not desired.

In some embodiments, for a manual spring balance board such as balance board 100, turning small gear 126 on the side of the board causes large gear 124 in the center to turn, thus moving the four springs either radially outward or radially inward using directing rods 134. Directing rods 134 convert the rotational movement of the gears into translational movement along rails 133, which act like tracks for spring packs 130.

In different embodiments, the platform of the balance board may be capable of tilting with different degrees of freedom. As used in this disclosure, a tilt of the platform may be alternatively called a tilt of the top plate or a tilt of the balance board. In some embodiments, such as those shown in FIGS. 1A-1E, the balance board may have two degrees of freedom, which allows the platform to be capable of independent or combined pitch and roll. In some embodiments, the combination of the two degrees of freedom, for example, the pitch and the roll, may be called the tilt value or simply the tilt of the balance board. In particular, in some embodiments, the top plate may rest on top of a two degree of freedom joint, such as center joint 128. Center joint 128 in turn is attached to base assembly 120, which may be placed or fixed stationary to the floor.

In some embodiments, the balance board may have a number of degrees of freedom other than two. For example, the balance board may be a one degree of freedom balance board, in which the top plate rotates around one axis. In such cases, the tilt may be a one degree of freedom tilt measured as the angle of rotation with respect to the horizontal positioning of the top plate.

In some embodiments, balance board 100 may be set to different levels of instability. In some embodiments, instability may be defined as the tendency of top plate 160 to tilt around center joint 128 in the direction of a torque applied to the top plate, as further described below. In various embodiments, the terms stability and instability may be used as opposite terms. For example, increasing instability of a balance board may be used interchangeably or replaced with the terms decreasing stability of the balance board. Conversely, decreasing instability of a balance board may be used interchangeably or replaced with the terms increasing stability of the balance board.

The external torque may, for example, result from one or more forces that are applied to off-center points on the top plate. In various embodiments, an off-center point may be at a point on the top plate other than the tilt center, the tilt center being defined as the point at which the top plate attaches to center joint 128. In various embodiments, the tilt center may or may not be the geographical center of the top plate. Moreover, in some embodiments, the one or more forces may be downward forces applied by a subject standing on top plate 160. In some embodiments, the downward forces may result from the weight of the subject or some pushing or pulling force applied by the subject, for example, by her feet. In such embodiments, therefore, the magnitude or direction of the external torque may change due to a change in the weight of the subject, the magnitude of the external force, the location of the center of gravity of the subject, or the location of the top plate at which the subject applies the force.

In some embodiments, the instability of the balance board may be set to different levels. In particular, a more unstable level (also known as a less stable level, i.e., a level with a higher level of instability) may be defined as a level in which the balance board responds to the same change in the external torque with a larger magnitude of tilt change. That is, for example, if a first level of the balance board is more unstable (i.e., has a higher level of instability) than a second level of the balance board, then for the same change in the external torque the balance board will change its tilt more (i.e., it exhibits a larger change in tilt angle) in the first level compared to the second level. In some embodiments, this means that the tilt change (i.e., change in the tilt angle) is an increasing function of instability for a fixed change in the external torque. In some embodiments, the starting tilt may be the zero tilt, that is, the platform may initially be fully horizontal. Moreover, at this zero tilt, the external torque as well as the counter torque maybe zero. In such cases, the tilt change may be the same as the final tilt, also simply called the tilt, of the platform. Moreover, the change in the external torque may be the same as the final external torque, also simply called the external torque. Therefore, in such embodiments, a more unstable level may be defined as a level in which the balance board responds to the same external torque with a larger magnitude of tilt. Therefore, this disclosure may interchangeably use the terms change in the tilt, tilt change, final tilt, or simply tilt. Similarly, this disclosure may interchangeably use the terms change in the external torque, torque change, final external torque, final torque, external torque, or simply torque. In each case, depending on the context, the disclosure may be interpreted as referring to the more general or to the special interpretation of these terms.

In some embodiments, the balance board is said to be in a physical equilibrium state, or simply in an equilibrium, when the total torque on platform 170 is zero. For balance board 100, for example, the equilibrium state may be achieved when the external torque is cancelled by the torques applied by one or more of springs 131. In some embodiments, the one or more torques applied by the springs are called counter torques. These counter torques may result from forces that one or more of the springs apply to the board due to being compressed or stretched, collectively called compression forces.

In some embodiments, when the balance board is in physical equilibrium, the tilt is fixed and does not change. This fixed tilt value for an equilibrium state may be called the equilibrium tilt corresponding to that equilibrium state. The equilibrium tilt for a fully horizontal top board that is in equilibrium state may therefore be zero tilt. The balance board, however, may come to an equilibrium state at a non-zero tilt. For balance board 100, such an equilibrium state may occur when, for example, an increase in the external torque causes platform 170 to increase its tilt, causing one or more of springs 131 to be compressed or stretched compared to their initial state (e.g., their initial compression state). These changes in the compression of those one or more springs causes changes in the compression forces applied by those springs, therefore changing the counter torques applied by the springs. The change in the tilt may continue until the counter torques cancel the external torques and platform 170 comes to a rest. For conciseness, the term compression is generally used to represent both compression and stretch of the spring, respectively considered to be positive and negative compressions. Similarly, the force exerted by the spring is generally called a compression force; in the case of a compressed spring the compression force is positive (directed outward in the direction of expansion) and for a stretched spring, the compression force is negative (directed inward in the direction of contraction).

In some embodiments, a manual spring balance board such as balance board 100 enables an operator to change the instability level of the balance board. More specifically, the operator may be able to manually turn small gear 126, causing large gear 124 to turn and thus move springs 131 closer or farther from the center. In some embodiments, moving springs 131 closer to the center increases the instability level because applying the same torque requires a larger magnitude of compression or extension of the springs to cancel the external torque. Conversely, in such embodiments, moving springs 131 farther from the center decreases the instability level of the balance board. In some environments, an operator may be able to manually turn small gear 126 by, for example, using a rod or a handle attached to the small gear.

In some embodiments, changing the instability of the balance board may further be achieved by changing the stiffness or the spring constant for one or more of the Springs. The stiffness may be changed by replacing the Springs with other Springs with different stiffness or by using Springs whose stiffness can be manipulated why are one or more parameters such as magnetic fields, temperature, attachments inside the string, etc.

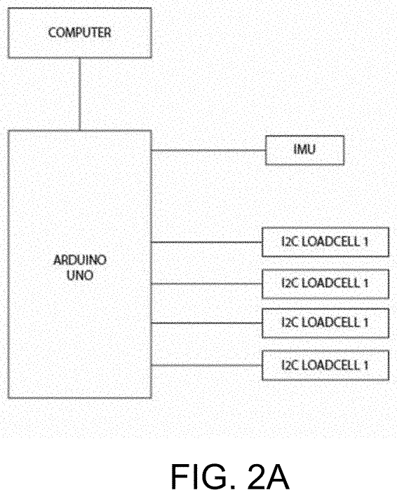

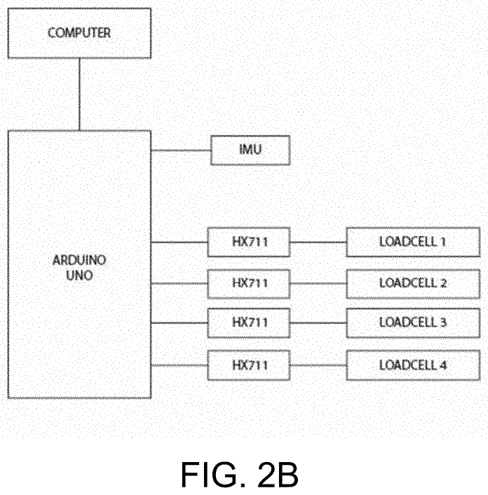

FIGS. 2A and 2B show block diagrams for two designs of an electronic hub such as electronic hub 138 according to some embodiments. As shown, the electronic hub may house in microcontroller and an inertial measurement unit (IMU). The microcontroller may be connected to the IMU and one or more load cells, such as the four load cells 142. Additionally, the microcontroller may be connected to a computer external to the system to transmit data and receive power.

Accelerometer and gyroscope data from the inertial measurement unit may be used with a Kalman filter to calculate tilt of the board. Furthermore, a smoothing function may be used to smooth the data.

In some embodiments like the embodiments shown in FIG. 2A, digital load cells interface with the microcontroller directly. In some other embodiments like the one shown in FIG. 2B, an amplifier and analog to digital converter such as the HX711 may be used to interface between the analog load cell and the microcontroller. Readings of the force applied to each load cell may be used to calculate the center of mass of the patient on the board.

As noted above, in this embodiment, the balance board can include an inertial measurement unit and four sets of load cells that are connected to a microcontroller. These sensors allow the system to quantitatively measure the patient's ability to maintain balance. FIG. 2A and FIG. 2B depict potential electrical systems of Board 1.2 (represented in FIG. 1A-1E).

FIGS. 2A-2B depict potential electrical systems of a balance board such as balance board 100 according to some embodiments. An inertial measurement unit (IMU), such as the MPU-6050 produced by SparkFun, contains both an accelerometer and a gyroscope. It is mounted underneath the plate on which the patient stands. Data from the accelerometer and gyroscope are used in a Kalman filter to calculate the tilt (pitch and roll) of the board.

By using the signals measured by the load cells and the inertial measurement unit to calculate patient center-of-mass distribution and board tilt, a user can understand how well the patient is able to maintain balance on the board. This evaluation of balance can be used for clinical assessment of the patient.

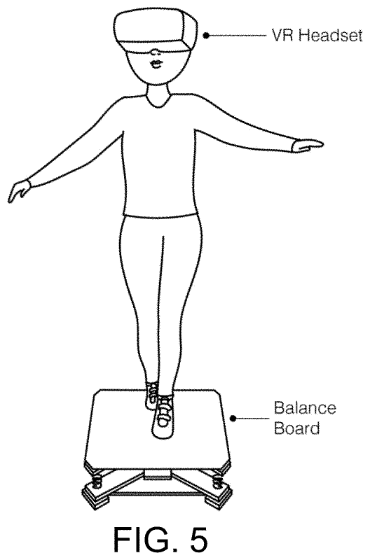

Signals measured by the load cells and the IMU can be used to dynamically modify the visual and/or auditory stimulus that the patient may be interacting with, as shown in FIG. 5. For example, in a VR environment, tilt input from the balance board can be used to alter the patient's visual stimulus. If the patient tilts on the board, for example, the signals from the load cells and the inertial measurement unit will reflect that tilt, and the VR environment may tilt correspondingly. The VR games may be programmed to record the patient's eye-tracking capability as well as translational and rotational head movements. These data points may be used as inputs for board stability. If the patient rotates their head to the right, for example, the VR headset may track that rotation, and the board may tilt right correspondingly. In this way, data collected from the board may serve as inputs that alter the patient's visual and/or auditory stimulus, and data collected from the patient's visual and/or auditory stimulus may serve as inputs that alter the board.

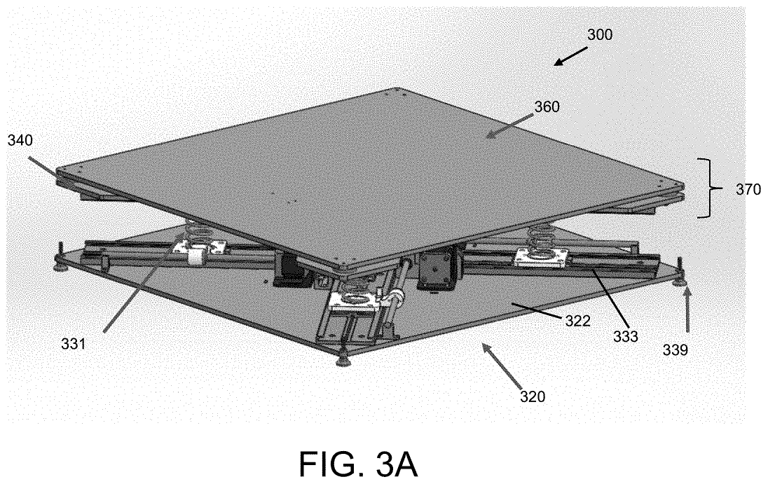

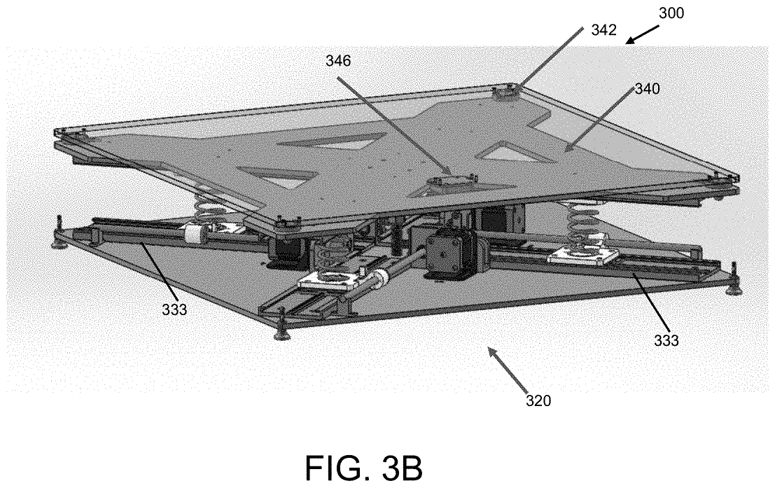

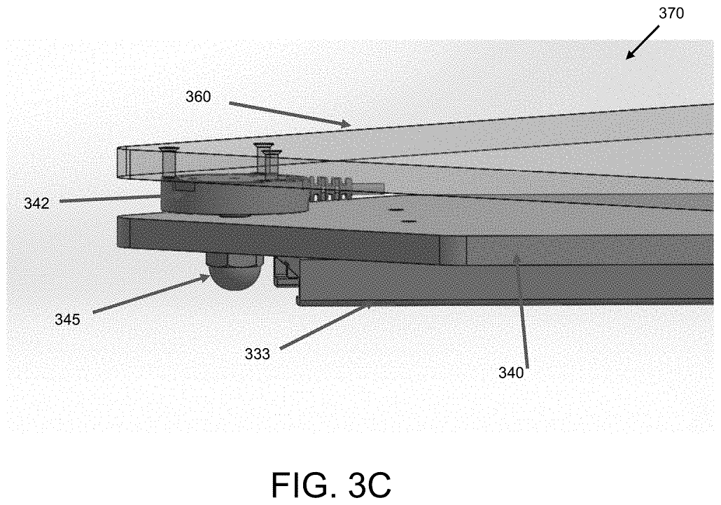

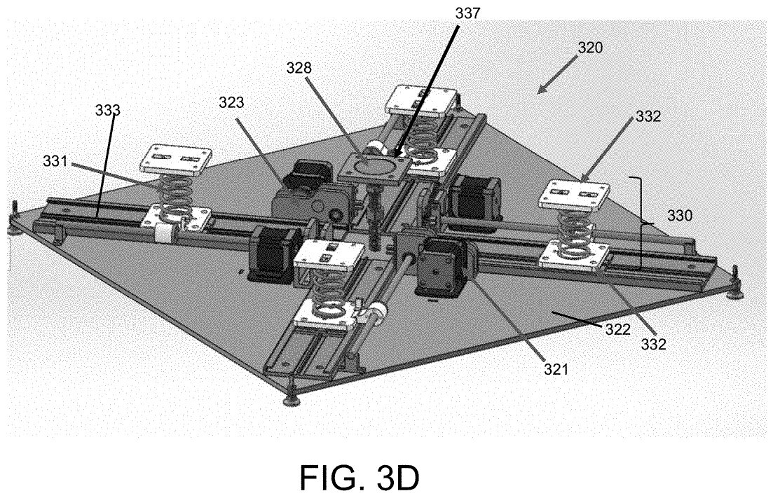

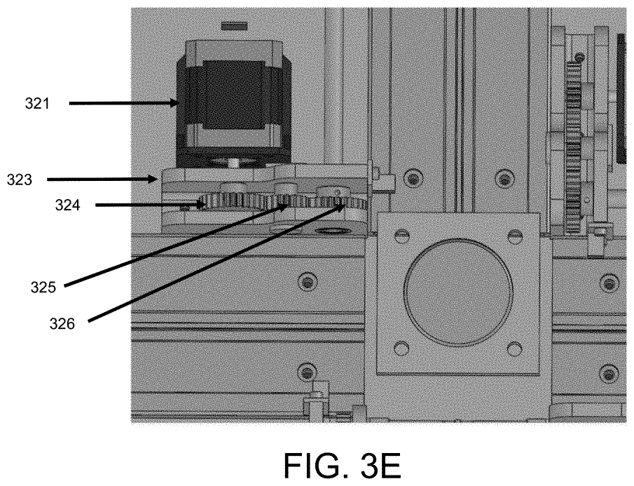

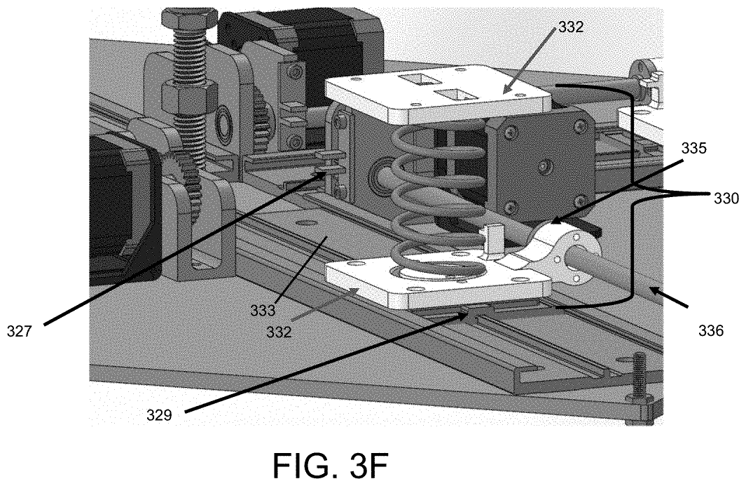

FIGS. 3A-3F show different views of a balance board 300 and its parts according to some other embodiments. In some embodiments, a balance board such as balance board 300 is called a motorized spring balance board for reasons explained further below. In some embodiments, motorized spring balance board 300 is similar to manual spring balance board 100 described above, except for replacing the manual mechanism for moving the spring packs with a motorized mechanism as described below. In some embodiments, balance board 300 may also differ from balance board 100 in other aspects, some of which are detailed below.

Balance board 300 includes a base assembly 320, a middle plate 340, and a top plate 360. Moreover, base assembly 320 includes a base plate 322, a center joint 328, a center joint plate 337, four spring packs 330, four pairs of rails 333, four stepper motors 321, four gear train holders 323, four motor shaft gears 324, four idler gears 325, four lead screw gears 326, four optical limit switches 327, four carriages 329, four lead screw nuts 335, and four supporting feet 339.

Each spring pack 330 includes a pair of spring holders 332, which hold between them a spring 331.

Moreover, there exist 4 load cells 342, four load cell connector nuts 345, and one inertial measurement unit (IMU) 346 between middle plate 340 and top plate 360. Middle plate 340 and top plate 360 together form a platform 370.

Base assembly 320, middle plate 340, and top plate 360 are supported by center joint 328 and four springs 331. Each spring 331 is included in one of the spring packs 330; and is confined in its two ends to a pair of spring holders 332 and compressed between base assembly 320 and middle plate 340.

Similar to balance board 100, balance board 300 is a two degree of freedom platform capable of independent or combined pitch and roll. While balance board 100 included a manual system of gears for moving the Springs, however, balance board 300 includes a motorized rail system for moving Springs 331 over rails 333, as described below. This movement is facilitated through a motorized actuation system and automated through use of microcontrollers and firmware. This mechanism enables setting the instability level of balance board 300 in a manner similar to balance board 100.

Some other parts of balance board 300 also enable mechanisms for tracking a user's center of gravity with respect from a center of the board and to measure the magnitude of the tilt of platform 170, as also further detailed.

The following describes some details of the structure of balance board 300 in one embodiment. In this embodiment, balance board 300 stands at ˜5.8 inches tall, 2 ft×2 ft wide and weighs 50 lbs. The system sits on 4 supporting feet 339, which are screwed into base plate 322. The base plate houses the main actuation components. Four rails 333 are attached to base plate 322 to create an X pattern (from corners to the center). These rails guide the movement of a carriage 329. Carriage 329 is in turn attached to a plastic spring holder 332, which houses and keeps a compression spring 331 in place. The bottom spring holder 332 has an inbuilt protrusion that allows a lead screw 336 to connect to it via a lead screw nut 335. This configuration allows for radial movement of the lead screw to be translated into a linear movement of the spring holder, which drives the spring pack and in turn the compression spring along the rail.

The lead screw is connected to a Nema 17 stepper motor through a gear train. Gear train holder 323 is attached to the bottom plate and houses three separate gears. Lead screw gear 326 attaches to the lead screw (by using a set screw) and is meshed to idler gear 325. The idler gear is meshed to motor shaft gear 324, which is connected to the motor shaft with a set screw. The radial movement of the motor shaft is then translated through this gear train (with a ratio of 1:1) to the lead screw, which moves the springs along the rail. The gear train holder also has an optical limit switch 327 connected to its side to be used for calibration purposes.

At the bottom side of the middle plate 340, another set of rails, carriages, and spring holders 332 are housed. The compression springs are connected to both top and bottom spring holders and are guided by both sets of rails. At the center of the bottom plate the center joint screws in. The center joint slots into a pocket in the center joint plate 337 that is attached to the middle plate. The middle plate is then supported by the compression springs along the diagonal and by the center joint at the center. Middle plate 340 connects to top plate 360 through load cells 342. In some embodiments, the load cells are screwed into the top plate while the threaded shaft of the load cell slots into the free fit hole on the middle plate. Then, using the load cell connector nut 345, the load cell is secured in place, and the middle and top plates are connected to one another. Finally, the top plate has threaded holes that allow an inertial measurement unit 346 to be attached onto it.

In some embodiments, electrical components on the board are controlled by an Arduino (or any other dedicated microcontroller) that communicates with the computer software. The stepper motors on the board are connected to an external power supply (12 Volts) and to 4 separate motor drivers. Knowing the parameters for the lead screw and the gear ratios, each step of the motor shaft is mapped to a certain pre-calculated linear distance that the springs take. The Arduino takes in commands from the computer software regarding the travel of the springs, translates it into a measure of motor shaft rotation, and sends this data to the motor drivers, which drive the stepper motor in the specified location up to the specified step.

Through a combination of firmware and computer software, balance board 300 provides multiple modes of operation, which allow for combined or independent movement of each compression spring. These modes include moving the springs to pre-set locations, moving the springs to a desired location as decided by the user, and homing the location of the springs. The homing routine is performed by moving the springs into the center until the optical switch is triggered by the protrusion on the bottom spring holder. That particular location is then saved in the microcontroller's memory as location 0.0 and any movement of the springs from that moment on is added onto this known location. The use of EEPROM memory allows balance board 300 to keep track of the location of the springs even if the board is powered down, which may in turn alleviate the need to calibrate the board each time it powers up.

The inertial measurement unit 346 that is connected to the top board may continuously stream accelerometer and gyroscope data to the microcontroller. This data is combined (after passing through a Kalman filter) to read out pitch and roll data. At the same time, the load cells provide a stream of force measurement (e.g., in units of lbs), which when interpreted by the firmware can be translated into a reading of the user's center of mass distribution. This data may be retrieved from the microcontroller to provide real time feedback to the operator.

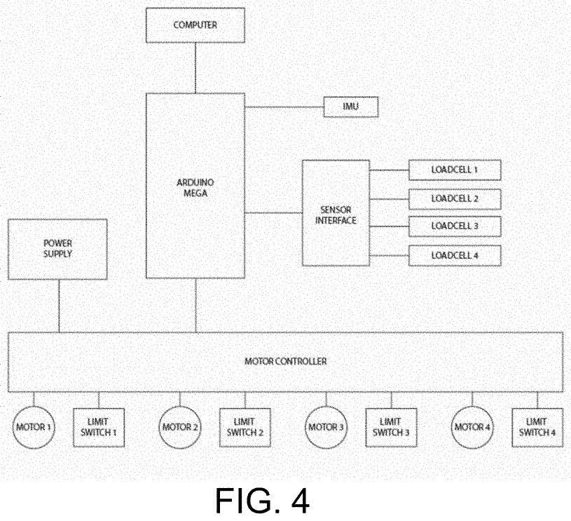

FIG. 4 depicts the electrical system of a balance board such as balance board 300 according to some embodiments. With reference to FIG. 4, a controller, which in this embodiment is an Arduino Mega connected to an inertial measurement unit (IMU) via I2C, a load sensor interface via UART, and a motor controller, may control the operation of the motor assemblies as well as obtain data generated by the sensors. The load sensor interface is connected to four analog load cells and converts analog signals to digital signals. The motor controller is connected to four sets of stepper motors and limit switches. A power supply is connected to the motor controller to provide power to the motors. The Arduino is connected to the computer by USB to receive and send data.

In balance board 300, each of the four motors may be used to adjust the position of the springs. The position of each motor is homed using the limit switch. Subsequent positions can be calculated based on the number of rotations.

In some embodiments, two-way communication with the computer happens via serial using a USB connection. Data from the board can be streamed at regular intervals or asynchronously based on requests from the computer. In balance board 300, for example, positions of individual springs may be electronically set from the computer.

To calculate the center of mass from the data generated by the four sets of load cells, the following relations were employed:

$${x}_{center} = \frac{( {F}_{1} + {F}_{2} ) - ( {F}_{3} + {F}_{4} )}{{\sum }_{n = 1}^{4} {F}_{n}}$$

$${y}_{center} = \frac{( {F}_{1} + {F}_{4} ) - ( {F}_{2} + {F}_{3} )}{{\sum }_{n = 1}^{4} {F}_{n}}$$

where F1 to F4 correspond to the force applied on the four load cells, starting with the bottom left corner and going around clockwise.

FIG. 5 shows a patient positioned on a platform of the balance board, according to some embodiments. The patient is wearing a VR headset that has built-in eye tracking. The balance board can collect data regarding the degree of balance exhibited by the patients as the patient is presented with a VR environment in which the patient is requested to perform various tasks. The data can be collected and analyzed, e.g., in a manner discussed above, to assess and/or rehabilitate the patient.

In some embodiments, in use, a patient can stand or sit on the top plate, and visual or audio stimuli can be provided to the patient, e.g., via a virtual reality device, as shown schematically in FIG. 5. As noted above, the patient's ability to maintain balance while receiving the visual or audio stimuli can be determined by receiving signals generated by the load cells and the inertial measurement unit. In particular, the movement of the patient on the top plate can cause the tilting of the top plate in one or two dimensions. The tilting can in turn be measured by the load cells and the inertial measurement unit. As discussed in more detail below, these signals can be processed to obtain a measure of the patient's balance on the platform.

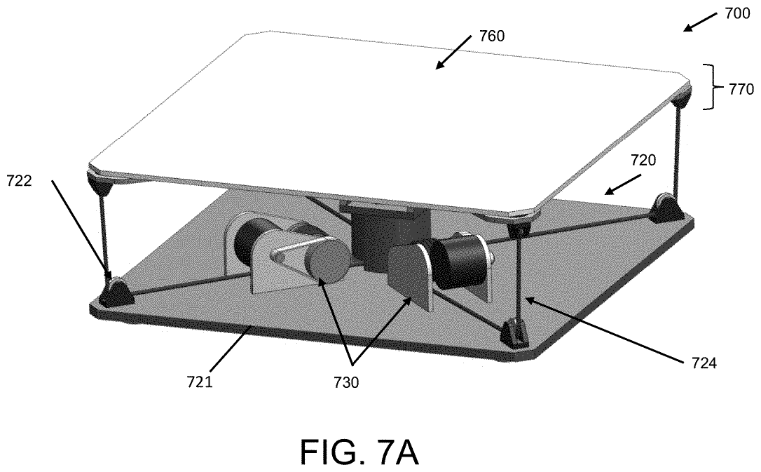

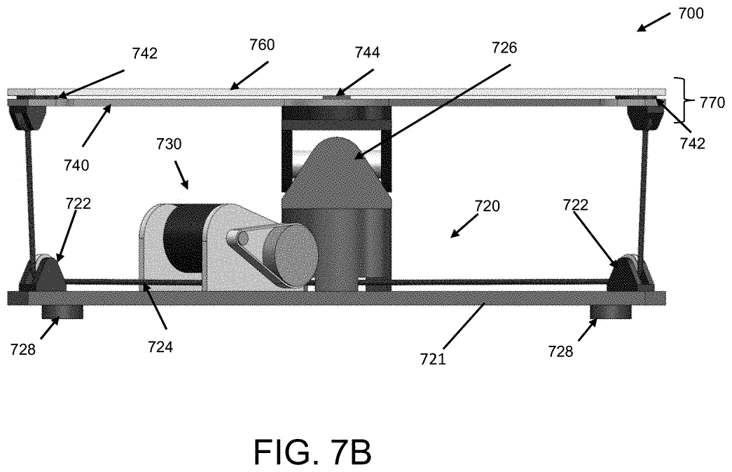

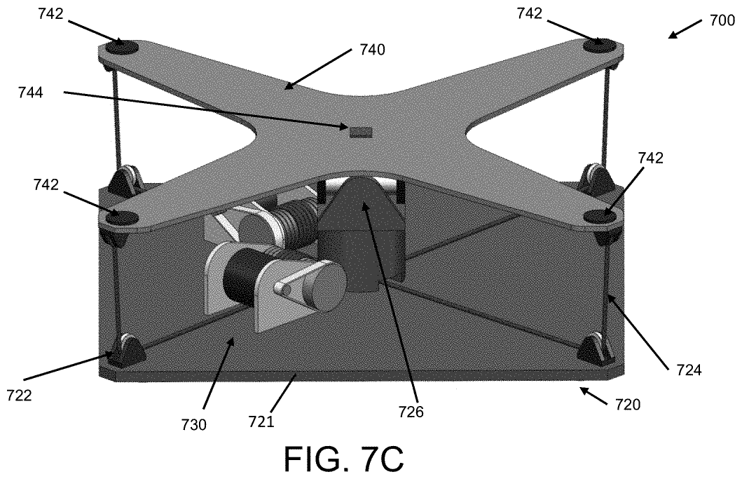

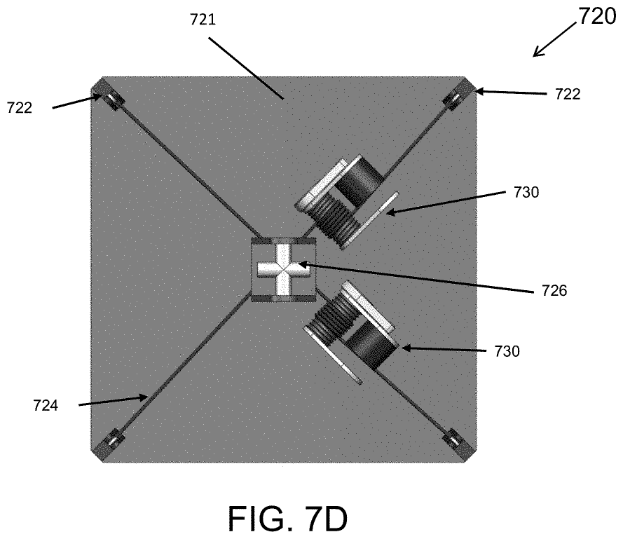

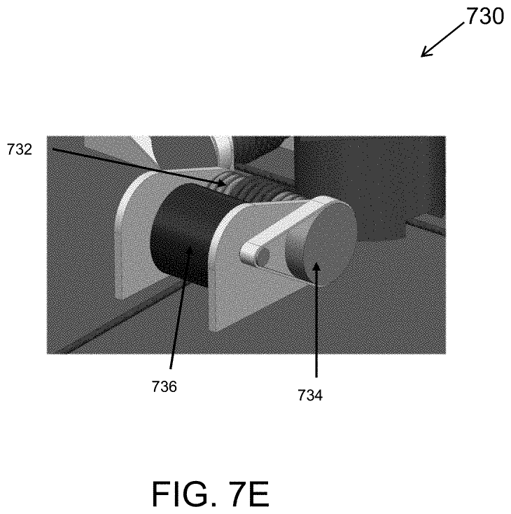

FIGS. 7A-7E show different views of a balance board 700 and its parts according to another embodiment. In some embodiments, a balance board such as balance board 700 is called a motorized cable balance board for reasons explained further below. As further detailed below, the cable balance board replaces the Springs in the spring balance boards with some cable mechanisms. In some embodiments, the motorized cable balance board is set to a spring simulation mode in which it Simulates a corresponding spring balance board, e.g., a corresponding manual spring balance board or a corresponding motorized spring balance board. A corresponding spring balance board may be defined as spring balance board that has characteristics similar to those of the motorized cable balance board. The characteristic may be selected to be, for example, one or more of the dimensions of the balance board, the type of use, or some other characteristic. In the spring simulation mode, the platform of the motorized cable balance board responds to a change in the external torque in the same manner that the corresponding spring balance board would respond to the same change in the external torque. The spring simulation mode is further detailed below.

Balance board 700 includes a base assembly 720, a middle plate 740, and a top plate 760. Middle plate 740 and top plate 760 together form platform 770.

In some embodiments, the top plate and the base plate may each have a square shape. Moreover, in some embodiments these two plates may have equal shapes. In some embodiments, they may be sized such that a person can comfortably stand on the top plate and tilt it by moving her center of gravity or pushing different points of the top plate, for example, with her feet. In some embodiments, each of these two plates may be a square with sides of the size 2 feet, 2.5 feet, three feet, or another size that is suitable for the above utilization.

Further, as seen in FIGS. 7C and 7D, between middle plate 740 and top plate 760 are located four load cells 742 and one inertial measurement unit (IMU) 744. In some embodiments, the middle plate and the top plate are fixedly attached to each other through the load cells, and therefore tilt as one unit.

Moreover, as seen in FIGS. 7A-7D, base assembly 720 includes a base plate 721 and, attached to base plate 721, four pulleys 722 (also called cable redirection pulleys), two cables 724, a joint 726, four supportive feet 728, and two spool assemblies 730. In some embodiments, joint 726 may be a universal joint.

Further, as seen in FIG. 7E, spool assembly 730 includes a cable spool 732, a belt-pulley assembly 734, and a motor 736.

In different embodiments, the balance board may be capable of tilting with different degrees of freedom. In some embodiments, such as those shown in FIGS. 7A-7D, balance board 700 may be a two degree of freedom platform capable of independent or combined pitch and roll. In particular, in some embodiments, top plate 760 may rest on top of a two degree of freedom joint 726. Joint 726 in turn is attached to base assembly 720, which may be placed or fixed stationary to the floor.

In some embodiments, the instability of balance board 700 may be set to different levels. In some embodiments, for example, the lowest value of instability may be zero instability, also called fully stable. At the fully stable level, for example, the balance board may stay stationary regardless of the magnitude or direction of the external torque. In various embodiments, staying stationary may mean that the balance board does not change its tilt in response to the external torque. In some embodiments, for example, the fully stable balance board may maintain a zero tilt regardless of the external torque. In some other embodiments, a fully stable balance board maintain a non-zero value of the tilt regardless of the external torque.

Moreover, in some embodiments, balance board 700 is also capable of moving throughout its full two degrees of freedom range of motion on its own, with or without an external torque. When the balance board is set to a specific tilt in the absence of any external torque, this tilt of the balance board may be called the equilibrium position of the balance board.

In some embodiments, at a non-zero instability level (also called an unstable level, defined as a level that is not fully stable) the balance board may respond to a change in the external torque by changing the tilt. Moreover, the level of instability of balance board 700 may be defined in a manner similar to those used before for balance board 100 or for balance board 300.

In some embodiments, balance board 700 may utilize one or two cables, such as cables 724, to control the magnitude or the direction of the tilt. As shown, for example, in FIGS. 7A-7D, cables 724 may be attached to the corners of middle plate 740. In particular, two ends of one cable may be attached to two diagonally opposing corners of the middle plate. Between its two ends, the cable may be routed through 2 pulleys 722 located underneath those two diagonally opposing corners of the middle plate, and further through one spool assembly 730. More specifically, in passing through the spool assembly, the cable may be wrapped around cable spool 732 of the spool assembly. In some embodiments, motor 736 may be rotated, thus rotating the cable spool attached to the motor, which causes the cable to move in one direction or the other, i.e., shorten on one side of the spool assembly and lengthen on the other side by the same amount. This motion of the cable in turn pulls down the platform at a first corner attached to the shortening side of the cable and allows an upward motion of the platform at a second corner that is diagonally opposed to the first corner and is attached to the lengthening side of the cable. Therefore, the tilt may be controlled by operating the motor and rotating it one specific direction or the opposing direction. In some environments, motor 736 may utilize a gear reduction mechanism.

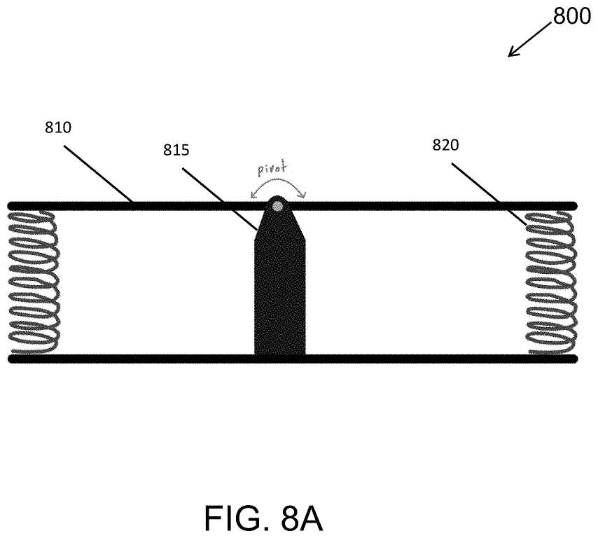

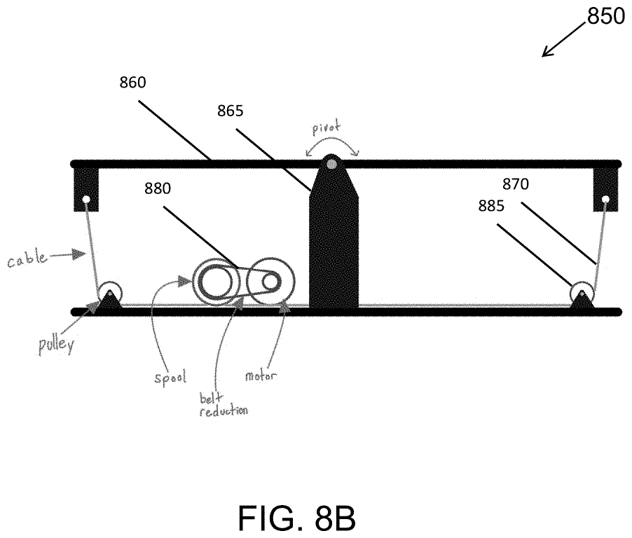

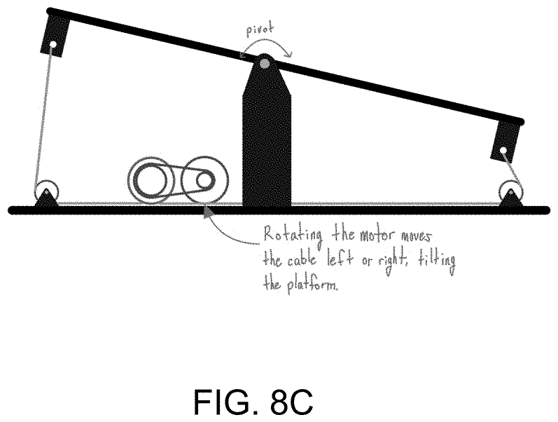

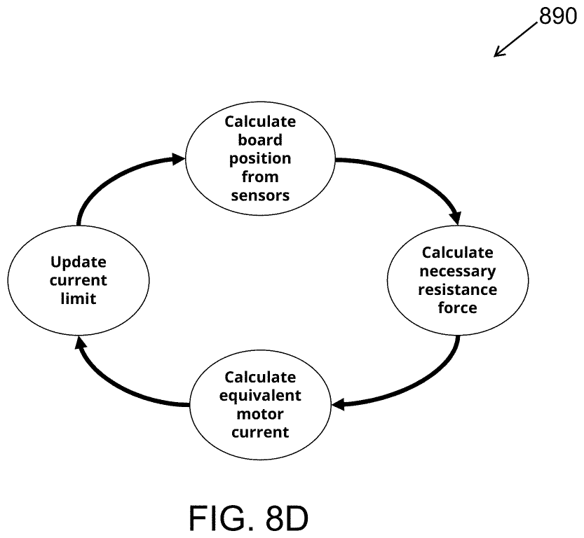

FIGS. 8A-8C illustrate the above discussed operation of the motorized cable balance board as compared to the spring balance boards according to some embodiments. These figures illustrate the concepts in a simplified 2-dimensional model of the balance board in which the platform can rotate with one degree of freedom.

In particular FIG. 8A, depicts a 2-dimensional spring balance board 800, which includes at platform 810, pivoting around a center joint 815, and resting unto Springs 820 located on the two sides of center joint 815. The instability level of balance board 800 may be changed by changing the stiffness of one or both of Springs 820 or, as discussed with respect to spring balance boards 100 and 300, by moving one or both of the Springs 820 closer or farther from center joint 815.

FIGS. 8B and 8C, on the other hand, illustrate some aspects of operation of motorized cable balance boards for a model 2-dimensional cable balance board 850. Balance board 850 includes a platform 860, a center joint 865, a cable 870, a motorized spool assembly 880, and two pulleys 885.

FIG. 8B shows balance board 850 at zero tilt, in which the platform is horizontal, or more generally is parallel to the floor. In FIG. 8B, on the other hand, 850 has been tilted so by the operation of motorized spool assembly 880, Which has rotated clockwise yeah causing the length of cable 870 to shorten on the right-hand side of motorized spool assembly 880 And lengthen on the left-hand side.

In some embodiments, the balance board is said to be in a physical equilibrium state, when the total torque applied to the top plate is zero. In such an equilibrium state, the magnitude of the tilt may be called equilibrium tilt. The equilibrium state may be achieved when the external torque is cancelled by the one or more torques applied by one or two cables, such as cables 724. In some embodiments, the torques applied by the cables are called counter torques.

In some embodiments, since the balance board's equilibrium tilt may vary to any pitch/roll combination within the balance board's range of motion, the motors' force may be a function of the difference between the balance board's equilibrium tilt and the actual tilt of the balance board. This function could be linear, exponential, or any other mathematical relationship. In order to vary the instability of the balance board, the balance board may vary the strength of the motor's restoring force. When balance board 700 is set to be more stable, i.e., less unstable, the motor's force response to a change in tilt is greater, as to more aggressively restore the balance board to its equilibrium position. When the balance board is set to be less stable, i.e., more unstable, the motors' force response to a change in tilt is decreased, as to make it more difficult for the balance board to be restored to its equilibrium position and easier, i.e., requiring less force, for the balance board to deviate from its equilibrium position.

FIG. 8D depicts the process of achieving force modulation of brushless motors via current control, as utilized in some embodiments, such as balance board 700. In these embodiments, current may be proportional to the torque of the motor. Accordingly, a high accuracy modulation of the current flowing through a motor allows for a high accuracy estimation of the motor's torque. The amount of force applied by a motor may be proportional to the angular distance from the current position of the board and the equilibrium position of the board. The direction of the force applied by a motor may be in the direction of the vector between the current position of the board and the equilibrium position of the board. The amount of current applied to a motor is calculated via an experimentally derived function corresponding to the relationship between the motor's torque and the motor's current.

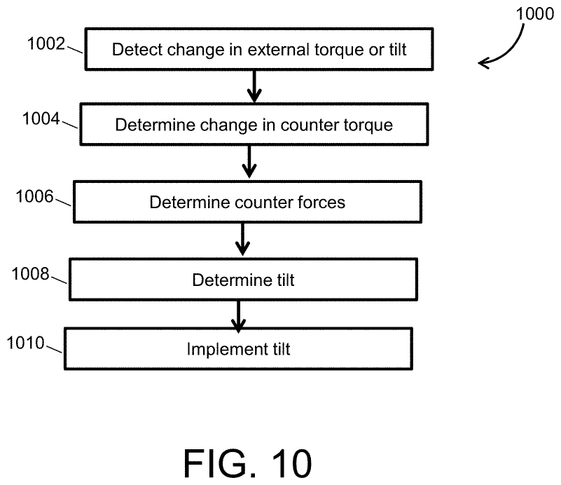

FIG. 8D depicts flow diagram 890 showing the cycle of steps taken in the balance board for the current in the Motors. In particular, in a step 892, the balance board determines the position, that is, the tilt of the balance board based on readings from one or more of its sensors, such as an IMU. In step 894, the balance board calculates the magnitude of necessary resistance force as described above and further detailed below in flow chart 1000 of FIG. 10. In step 896, the balance board calculates an equivalent motor current based on the resistance force. In step 898, the balance board updates the current limit accordingly.

In some embodiments, balance board 700 may be set to operate in different operating modes. In a first operating mode, the equilibrium tilt is set to be zero, that is, the platform is set to be horizontal or, more generally, parallel to the floor. In this mode, the instability of the balance board may vary in a manner detailed below.

In a second operating mode, on the other hand, the equilibrium tilt may be set to vary over time. In this mode, also, the instability of the balance board may vary from stable to different levels of instability.

In different embodiments, balance board 700 is enabled to measure the forces or torques applied to the platform or tilt of the platform via one or more of its Motors, load cells, or IMU. Moreover, in some embodiments, balance board 700 is enabled to determine the counter torque in response to the measured external torque and accordingly adjust the torques applied by one or more of the Motors. In some embodiments, the counter torque is set to cancel the external torque.

Further, in some embodiments, when the external torque applied to a balance board that is in equilibrium changes, the total torque applied to the platform becomes non-zero, causing the platform to change its tilt from its initial equilibrium tilt in accordance with laws of physics. Further, due to the change in the external torque, balance board 700 may adjust the counter torque applied by the Motors. In some embodiments, motor 736 is controlled by a motor controller that enables measuring and controlling the current running through the motor and in this manner, controls the force applied by the motor.

Moreover, in some embodiments, balance board 700 may determine a new equilibrium tilt based on the level of instability and the new value of the external torque. The balance board may accordingly use the determined new equilibrium tilt to determine the length of one or both of the cables on each side of each motor. Balance board 700 may then readjust the length of the cables based on the determinations. The platform may then come to rest at the new equilibrium tilt.

In different embodiments, the balance board may determine the new equilibrium tilt in different ways. For example, in the spring simulation mode mentioned above, which can be one example of a passive mode, the new equilibrium tilt may be determined to be the same as the equilibrium tilt in a corresponding manual spring balance board, or in a corresponding motorized spring balance board, that is set to the same level of instability. More specifically, the amount of the required counter torque may determine the amount of the counterforce required from each spring in the corresponding spring balance board. The amount of the counterforce and the stiffness of the Springs in turn determine the amount of compression in the Springs. Moreover, the level of instability may be mapped to the location of the Springs or the magnitudes of their stiffness (e.g., represented by the spring constant) under the platform. Combining the amount of compression and the location of each spring will determine the tilt of the platform.

In some embodiments, therefore, the motorized cable balance board can operate in different active or passive modes. In the active mode, the balance board is able to set an equilibrium tilt independent of the external torque or the changes of the external torque. In different passive modes, however, the balance board reacts to the external torque or to the changes in the external torque and accordingly adjusts the counter torque, the tension in the cables, or the length of the cables on the sides of the Motors. In these modes, the balance board responds to the changes in the external torque by accordingly changing its tilt. Moreover, in its spring simulation mode, the motorized cable balance board is able to simulate a spring balance board. Further, in its passive modes, the motorized cable balance board is able to change its response in accordance with a setting of its level of instability.

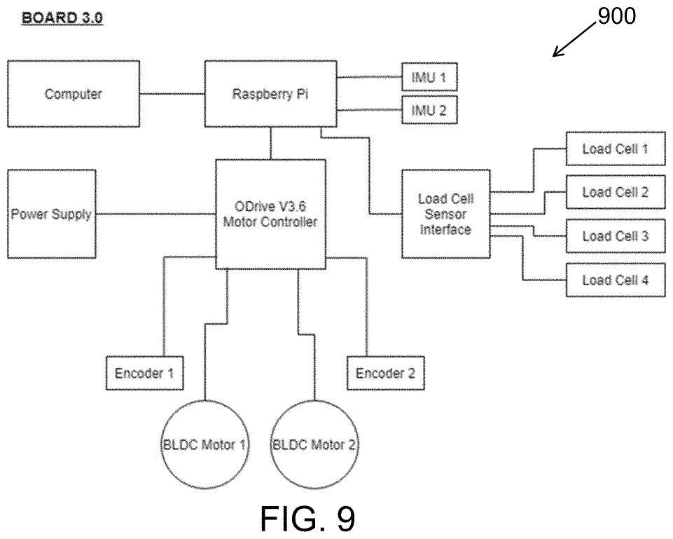

FIG. 9 depicts a diagram 900 of an electrical system of a balance board, such as balance board 700, according to some embodiments. In diagram 900, a controller, which in this embodiment is a Raspberry Pi is connected to an inertial measurement unit (IMU) via I2C, a load sensor interface via UART, and a brushless DC motor controller. The controller may control the operation of the motor assemblies as well as obtain data generated by the sensors. The load sensor interface is connected to four analog load cells and converts analog signals to digital signals. The motor controller is connected to two brushless DC motors. A power supply is connected to the motor controller to provide power to the motors. The Raspberry Pi (or other microcontroller) is connected to the computer by USB to receive and send data.

In some embodiments, accelerometer and gyroscope data from the IMU are used with a Kalman filter to calculate tilt of the board. Furthermore, a smoothing function may be used to smooth the data.

In some embodiments, the analog readings from the load cells are converted to digital values representing force applied. The forces from the four load cells are used to calculate the center of mass of the patient on the board.

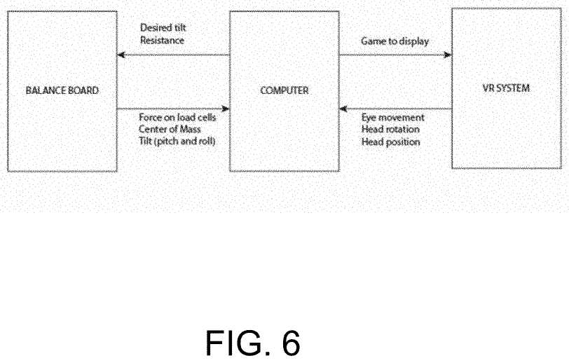

FIG. 6 shows the flow of data between the balance board, computer, and VR system according to some embodiments. The computer acts as the central hub where most of the processing happens. It sends the desired tilt (pitch and roll) angles and resistance (e.g., restoring force strength) to the balance board. The balance board sends a stream of force readings on the four load cells, calculated center of mass, and current tilt (pitch and roll) angles calculated from the inertial measurement unit to the computer. The computer sends the game data to be displayed to the VR system and receives the headset position, headset rotation, and eye movement information from the VR system.

FIG. 10 show a flow chart 1000 for a process performed by a balance board according to some embodiments.

In step 1002, the balance board detects a change in the external torque applied to the platform. In some embodiments, the change in the external torque may also be accompanied by a change in the tilt of the platform. In some embodiments, these changes may be detected by one or more sensors attached to the balance board. The sensors may include, for example, one or more accelerometers, one or more IMU's, etc. Moreover, the balance board may utilize a computer or one or more processors to determine the external torque based on measured external forces or distances.

In step 1004, the balance board determines a required change in the counter torque. In some in embodiments, the required counter torque is determined as a torque that cancels the change of the external torque. In some embodiments, the required change in counter torque is determined such that the total counter torque cancels the total external torque. Moreover, in step 1004, the balance board may also determine more than one counter torques that need to be applied at different points of the platform. The one or more torques may apply at different points at which some sources of counterforce contact the platform. Those points may, for example, include points of contact of one or more Springs or one or more cables attached to the platform. The magnitude and direction of the one or more counter torques may therefore depend on the locations of the points of contact in addition to the magnitude of the change of the external torque or the external torque.

In step 1006, the balance board determines the magnitude of the counter forces or the magnitude of the changes of the counter forces based on the previously determined one or more counter torques. The magnitude of the counter forces may depend on the location of the points of contact and their distances with the center of tilt or axis of tilt, in addition to depending on the magnitude of the counter torques.

In step 1008, the balance board determines the tilt or the change in the tilt. The change in the tilt may be determined by one variable (for example, for a one-dimensional tilt around an axis) or by more than one variable (for example, by two variables, for a 2 dimensional tilt around a center joint). The tilt may depend on the level of instability of the balance board. For a motorized cable balance board, for example, the level of instability may determine the location of the Springs in the corresponding spring balance board. Further, those locations and the determined counter forces applied by each spring, may determine the magnitude of compression or the change in compression of each spring. Finally, the change in compression of the spring and its location with respect to the center of tilt, may determine the angle of tilt or the change in the angle of tilt.

In step 1010, the balance board implements the tilt by changing the tilt of the balance board. Moreover, the balance board may implement the tilt by changing the counter forces as determined. The change in tilt or in the counter force may be implemented by, for example, moving the cable and changing the tension of the cables by the motor in a motorized cable balance board such as balance Board 700.

CONCLUSION AND GENERAL TERMINOLOGY

The above detailed description refers to the accompanying drawings. The same or similar reference numbers may have been used in the drawings or in the description to refer to the same or similar parts. Also, similarly named elements may perform similar functions and may be similarly designed, unless specified otherwise. Details are set forth to provide an understanding of the exemplary embodiments. Embodiments, e.g., alternative embodiments, may be practiced without some of these details. In other instances, well known techniques, procedures, and components have not been described in detail to avoid obscuring the described embodiments.

The foregoing description of the embodiments has been presented for purposes of illustration only. It is not exhaustive and does not limit the embodiments to the precise form disclosed. While several exemplary embodiments and features are described, modifications, adaptations, and other implementations may be possible, without departing from the spirit and scope of the embodiments. Accordingly, unless explicitly stated otherwise, the descriptions relate to one or more embodiments and should not be construed to limit the embodiments as a whole. This is true regardless of whether or not the disclosure states that a feature is related to “a,” “the,” “one,” “one or more,” “some,” or “various” embodiments. As used herein, the singular forms “a,” “an,” and “the” may include the plural forms unless the context clearly dictates otherwise. Further, the term “coupled” does not exclude the presence of intermediate elements between the coupled items. Also, stating that a feature may exist indicates that the feature may exist in one or more embodiments.

In this disclosure, the terms “include,” “comprise,” “contain,” and “have,” when used after a set or a system, mean an open inclusion and do not exclude addition of other, non-enumerated, members to the set or to the system. Further, unless stated otherwise or deducted otherwise from the context, the conjunction “or,” if used, is not exclusive, but is instead inclusive to mean and/or. Moreover, if these terms are used, a subset of a set may include one or more than one, including all, members of the set.

Further, if used in this disclosure, and unless stated or deducted otherwise, a first variable is an increasing function of a second variable if the first variable does not decrease and instead generally increases when the second variable increases. On the other hand, a first variable is a decreasing function of a second variable if the first variable does not increase and instead generally decreases when the second variable increases. In some embodiment, a first variable may be an increasing or a decreasing function of a second variable if, respectively, the first variable is directly or inversely proportional to the second variable.

The disclosed systems, methods, and apparatus are not limited to any specific aspect or feature or combinations thereof, nor do the disclosed systems, methods, and apparatus require that any one or more specific advantages be present, or problems be solved. Any theories of operation are to facilitate explanation, but the disclosed systems, methods, and apparatus are not limited to such theories of operation.

Modifications and variations are possible in light of the above teachings or may be acquired from practicing the embodiments. For example, the described steps need not be performed in the same sequence discussed or with the same degree of separation. Likewise, various steps may be omitted, repeated, combined, or performed in parallel, as necessary, to achieve the same or similar objectives. Similarly, the systems described need not necessarily include all parts described in the embodiments and may also include other parts not described in the embodiments. Accordingly, the embodiments are not limited to the above-described details, but instead are defined by the appended claims in light of their full scope of equivalents. Further, the present disclosure is directed toward all novel and non-obvious features and aspects of the various disclosed embodiments, alone and in various combinations and sub-combinations with one another.

While the present disclosure has been particularly described in conjunction with specific embodiments, many alternatives, modifications, and variations will be apparent in light of the foregoing description. It is therefore contemplated that the appended claims will embrace any such alternatives, modifications, and variations as falling within the true spirit and scope of the present disclosure.

What is claimed is:

1. A balance board, comprising:
a base plate for positioning the balance board on a surface; and
a platform coupled to the base plate via one or more adjustable couplings configured to allow changing a stability of the platform.

2. The balance board of claim 1, wherein the platform is configured to:
undergo a tilt in response to a torque applied to the platform;
increase a magnitude of the tilt by a tilt increase in response to an increase in a magnitude of the torque by a torque increase; and
upon decreasing the stability of the platform, increase a magnitude of the tilt increase in response to the same torque increase.

3. The balance board of claim 1, wherein the platform is further configured to apply a counter torque to balance against an external torque applied to the platform.

4. The balance board of claim 3, wherein the platform is further configured to:
receive a tilt-change resulting from a change in the external torque; and
create a change in the counter torque based on the tilt-change, wherein the change in the counter torque balances the change in the external torque.

5. The balance board of claim 4, further comprising a force source applying a counter force to the platform, wherein the counter force generates the counter torque.

6. The balance board of claim 4, wherein decreasing the stability causes the tilt-change to increase for the same change in the external torque.

7. The balance board of claim 4, wherein the balance board is configured to allow the tilt-change is in two dimensions.

8. The balance board of claim 5, wherein:
the force source includes a spring located between the base plate and the platform; and
the counter force includes a compression force applied by the spring to the platform, the compression force resulting from a compression of the spring.

9. The balance board of claim 8, wherein:
the tilt-change causes a change in the compression of the spring;
the change in the compression of the spring causes a change in the compression force; and
the change in the compression force causes the change in the counter torque.

10. The balance board of claim 9, wherein:
the spring is configured to be movable radially so as to allow adjusting a distance between the spring and a center of the platform; and
the change in the compression of the spring depends on the distance.

11. The balance board of claim 10, wherein decreasing the distance decreases the stability of the platform.

12. The balance board of claim 10, wherein decreasing the distance increases the change in compression required to balance the same change in the external torque.

13. The balance board of claim 5, wherein:
the force source includes a cable attached to the platform; and
the counter force includes a tension force applied by the cable to the platform.

14. The balance board of claim 13, wherein the tilt-change causes a change in the tension force.

15. The balance board of claim 13, wherein:
the cable is attached by its two ends to two attachment points on the platform; and
the tension force results from two cable tensions applied by the cable to the platform at the two attachment points.

16. A method comprising:
detecting an external torque applied to a platform of balance board;
based on the determined external torque, determining a counter torque;
based on the determined counter torque, determining a tilt of the platform; and
based on the determined tilt, tilting the platform.

17. The method of claim 16, wherein:
determining the tilt includes determining a magnitude of compression of a spring.

18. The method of claim 17, wherein the balance board is a motorized cable balance board and the spring is included in a spring balance board corresponding to the motorized cable balance board.

19. The method of claim 17, wherein:
determining the magnitude of the compression depends on a level of instability of the balance board.

20. The method of claim 19, wherein the level of instability of the balance board determines a location of the spring.
